(19) United States
(12) Patent Application Publication
(10) Pub. No.: US 2013/0021572 A1
(43) Pub. Date: Jan. 24, 2013

(54) LIQUID CRYSTAL DISPLAY DEVICE ELEMENT, METHOD FOR MANUFACTURING SAME, AND LIQUID CRYSTAL DISPLAY DEVICE

(71) Applicants: Masao Urayama, Osaka-shi (JP); Masanori Umeya, Tokyo (JP); Atsushi Sugizaki, Tokyo (JP)

(72) Inventors: Masao Urayama, Osaka-shi (JP); Masanori Umeya, Tokyo (JP); Atsushi Sugizaki, Tokyo (JP)

(73) Assignees: SHARP KABUSHIKI KAISHA, Osaka-shi, Osaka (JP); SUMITOMO BAKELITE CO., LTD., Tokyo (JP); DAI NIPPON PRINTING CO., LTD., Tokyo (JP)

(21) Appl. No.: 13/637,713

(22) PCT Filed: Jan. 21, 2011
(86) PCT No.: PCT/JP2011/051120

§ 371 Date: Sep. 27, 2012

(30) Foreign Application Priority Data
Mar. 31, 2010 (JP) 2010-083710

(51) Int. Cl. G02F 1/1339

(52) U.S. Cl. 349/153; 349/190

(57) ABSTRACT

A liquid crystal display element (10) in accordance with the present invention includes: a pair of substrates (1), at least one of which is a flexible substrate; a liquid crystal layer (3) sealed in a gap between the pair of substrates (1); and spacer members (4), provided between the pair of substrates (1), which sustain the gap between the pair of substrates (1). A thickness of the liquid crystal layer (3) falls in a range of 93% to 98% of heights of the spacer members (4) while no pressure is applied to the spacer members. Adjacent spacer members (4) are provided at intervals of less than 400 μm.

### TECHNICAL FIELD

The present invention relates to (i) a liquid crystal display element using a flexible substrate, (ii) a method for manufacturing the liquid crystal display element, and (iii) a liquid crystal display device.

### BACKGROUND ART

Generally, a liquid crystal display (LCD) is constructed through (i) providing (a) a back substrate including a thin film transistor (TFT), pixel electrodes, and an alignment film and (b) a front substrate including a color filter, electrodes, and an alignment film, (ii) aligning the substrates with each other, and (iii) filling a gap between the substrates with a liquid crystal. In manufacturing an LCD, evenness and stability of a gap (cell gap) between such substrates are crucial factors in high display quality (see Patent Literature 1, for example).

In recent years, there have been attempts to use, as a substrate, a plastic film (such as a polyimide film) in stead of a conventional glass substrate, so that an LCD can be made light and/or flexible. Also, as a method for manufacturing an LCD including such a flexible substrate, roll-to-roll processing has been the focus of attention from the perspective of enhancement of efficiency in manufacturing LCDs. In roll-to-roll processing, a one-drop-fill method (ODF method) has been employed in order to carry out, as a continual series of steps, steps of (i) forming a seal for sealing a liquid crystal, (ii) combining, with use of the seal, a back substrate and a front substrate together, and (iii) curing the seal.

The amount of a liquid crystal to be supplied by the ODF method is required to be equal to the capacity of a liquid crystal layer to be formed. Otherwise, an excess portion of the liquid crystal might change the shape of a cell gap so that a desired performance of a liquid crystal display might not be achieved. Hence, in the current system of manufacturing an LCD with the use of glass substrates, the capacities of columnar spacer members for forming a gap, in which to provide a liquid crystal layer, are measured by use of in-line measurement in order to precisely determine the amount of a liquid crystal to be supplied.

On the other hand, in case of an LCD using a flexible substrate(s), a surface of the LCD is prone to flexure or undulation due to lack of solidity of the flexible substrate(s) itself/themselves. This causes inconsistent thickness of a cell gap throughout its surface even if the amount of a liquid crystal to be supplied is precisely determined.

Given this problem, Patent Literature 2 discloses a technology allowing the stability of a cell gap to be maintained even in case of an LCD using a flexible substrate. Specifically, a back substrate and a front substrate are combined together without variation in overall thickness by combining the substrates together via columnar spacer members. This allows the stability of the cell gap to be maintained.

### CITATION LIST

### Patent Literatures

Patent Literature 1

Japanese Patent Application Publication, Tokukai, No. 2001-075111 A (Publication Date: Mar. 23, 2001)

Patent Literature 2

Japanese Patent Application Publication, Tokukai, No. 2006-338011 A (Publication Date: Dec. 14, 2006)

### SUMMARY OF INVENTION

### Technical Problem

However, in the case where a back substrate and a front substrate are combined together via columnar spacer members as with the technology disclosed in Patent Literature 2, sections of attachment are subjected to stress from a deformation of an LCD (when the deformation occurs) and consequently receives damages. Hence, the technology is unsuitable for an LCD designed for use requiring flexibility of the LCD.

The present invention has been made in view of the problem, and it is an object of the present invention to provide a liquid crystal display element capable of maintaining a well-balanced distribution of a cell gap even when using a flexible substrate.

### Solution to Problem

In order to attain the object, a liquid crystal display element in accordance with the present invention includes: a pair of substrates, at least one of which is a flexible substrate; a liquid crystal layer sealed in between the pair of substrates; a plurality of spacer members, provided between the pair of substrates, which sustain a gap between the pair of substrates, the liquid crystal layer having a thickness falling in a range of 93% to 98% of heights of the spacer members in a thickness direction of the liquid crystal layer, which heights the spacer members have under no pressure applied to the spacer members, and the spacer members being provided at intervals of less than 400 μm therebetween.

In the configuration, the heights of the spacer members determine a length between the pair of substrates. The thickness of the liquid crystal layer is set to be slightly less (93% to 98%) than the height of each of the spacer member while no pressure is applied to the spacer member, which height is equivalent to a length between the pair of substrates before the liquid crystal is sealed in.

The liquid crystal is sealed in between the pair of substrates in such a way that the liquid crystal is in contact with each of the pair of substrates. In so doing, the spacer members receive, together with the liquid crystal layer, pressure from both of the pair of substrates. Since the spacer members are typically made of elastic resin, the heights of the spacer members become lower as compared to those before the liquid crystal layer is sealed in, which is when no pressure is applied to the spacer members. That is, the gap between the pair of substrates becomes slightly narrower.

With the configuration, (i) the thickness of the liquid crystal layer fits the gap between the pair of substrates so that an excess portion of a liquid crystal is non-existent and (ii) at least one of the pair of substrates, which is a flexible substrate, is stabilized in a state of being slightly inwardly flexed so as to be in contact with the liquid crystal.

Nevertheless, in a liquid crystal display element having spacer members provided at intervals of not less than 400 μm, a flexible substrate becomes flexed to a greater extent due to the large pitches, so that an in-plane standard deviation in the distribution of the cell gap degenerates. Given this factor, however, it is possible to suitably maintain the gap between the pair of substrates by arranging the intervals between the spacer members to be less than 400 μm.

Therefore, in a liquid crystal display in accordance with the present invention, the thickness of the liquid crystal layer and the intervals between the spacer members are set as described above so that a well-balanced in-plane distribution of the cell gap can be maintained.

Note that, in the liquid crystal display in accordance with the present invention, the thickness of the liquid crystal layer is set to be not less than 93% of the heights of the spacer members while no pressure is applied to the spacer members so that bubbles are prevented from appearing in the liquid crystal layer.

A liquid crystal display device in accordance with the present invention includes any one of the liquid crystal display element described above.

With the configuration, it is possible to provide a liquid crystal display device delivering high-quality images.

In order to solve the problem, a method in accordance with the present invention is a method for manufacturing a liquid crystal display element, said liquid crystal display element, comprising: a pair of substrates, at least one of which is a flexible substrate; a liquid crystal layer sealed in between the pair of substrates; a plurality of spacer members, provided between the pair of substrates, which sustain a gap between the pair of substrates, said method, comprising the steps of: (i) providing, on one of the pair of substrates, the plurality of spacer members at pitches of less than 400 μm; and (ii), after the step (i), sealing a liquid crystal in between the pair of substrates, the liquid crystal being sealed in such an amount that the liquid crystal layer will have a thickness falling in a range of 93% to 98% of heights of the spacer members in a thickness direction of the liquid crystal layer, which heights the spacer members have under no pressure applied to the spacer members.

With the method in accordance with the present invention, it is possible to manufacture a liquid crystal display element in which a well-balanced in-plane distribution of a cell gap is maintained.

Additional objects, features, and strengths of the present invention will be made clear by the description below. Further, the advantages of the present invention will be evident from the following explanation in reference to the drawings.

### Advantageous Effects of Invention

The present invention includes: a pair of substrates, at least one of which is a flexible substrate; a liquid crystal layer sealed in between the pair of substrates; a plurality of spacer members, provided between the pair of substrates, which sustain a gap between the pair of substrates, the liquid crystal layer having a thickness falling in a range of 93% to 98% of heights of the spacer members in a thickness direction of the liquid crystal layer, which heights the spacer members have under no pressure applied to the spacer members, and the spacer members being provided at intervals of less than 400 μm therebetween. This makes it possible to provide a liquid crystal display element in which a well-balanced in-plane distribution of a cell gap is maintained.

### BRIEF DESCRIPTION OF DRAWINGS

FIG. 1 is a cross-sectional view schematically illustrating a liquid crystal display element in accordance with the present embodiment.

FIG. 2 is a top view schematically illustrating the liquid crystal display element in accordance with the present embodiment.

FIG. 3 is a graph illustrating a correlation, in the liquid crystal element, between (i) the ratio of a liquid-crystal-filling amount to a cell capacity and (ii) the in-plane distribution of a cell gap.

### DESCRIPTION OF EMBODIMENTS

The following description will discuss, with reference to the drawings, an embodiment of a liquid crystal display element in accordance with the present invention.

(Configuration of Liquid Crystal Display Element 10)

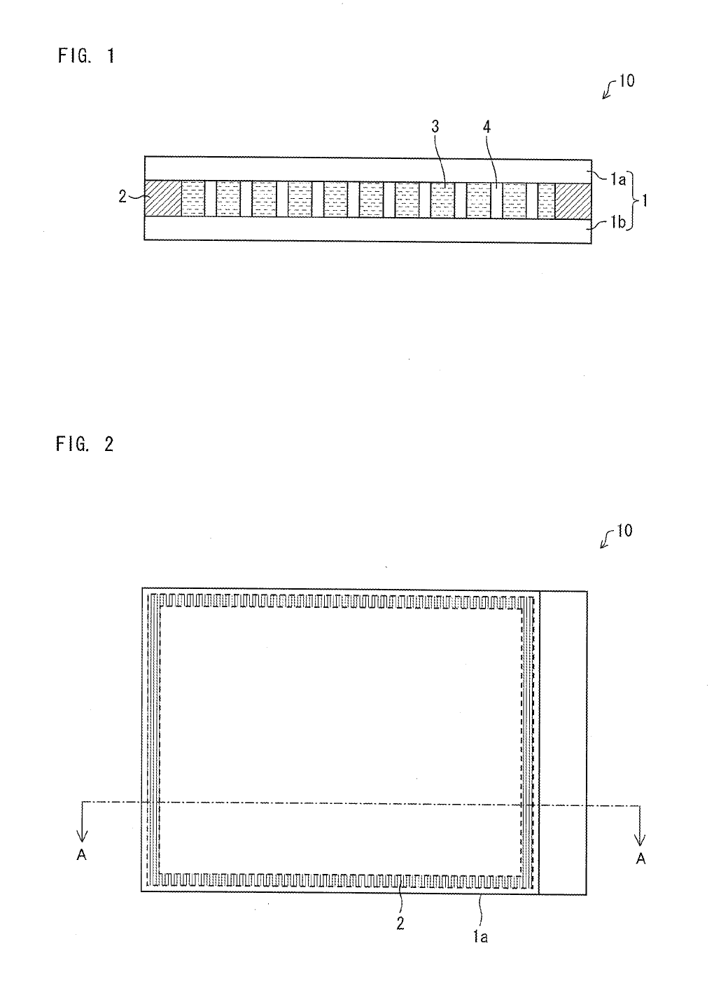

A configuration of a liquid crystal display element 10 will be schematically described below with reference to FIG. 1 and FIG. 2. FIG. 1 is a cross-sectional view illustrating the liquid crystal display element 10 of the present embodiment, and FIG. 2 is a top view of FIG. 1. FIG. 1 is a cross-sectional view taken along the line A-A′ of the liquid crystal display element illustrated in FIG. 2.

Note that FIG. 1 and FIG. 2 illustrate only main components of the liquid crystal display element 10. Also note that FIG. 1 illustrates, in an exaggerating manner for convenience, (i) a space (cell gap) between a pair of substrates 1 and (ii) members in the space.

As illustrated in FIG. 1 and FIG. 2, the liquid crystal display element 10 basically includes (i) a front substrate 1a and a back substrate 1b together constituting the pair of substrates 1, (ii) a liquid crystal layer 3 provided between the pair of substrates 1, (iii) a sealant 2 for sealing the liquid crystal layer 3, and (iv) a plurality of spacer members 4 for sustaining the cell gap between the pair of substrates 1.

At least one of the front substrate 1a and the back substrate 1b together constituting the pair of substrates 1 is a flexible substrate. A material for the front substrate 1a and the back substrate 1b each is not limited to a particular one, provided that the material is substantially transparent. Examples of such a material encompass glass, ceramic, and plastic. Examples of plastic encompass: cellulose derivatives such as cellulose, triacetylcellulose, diacetyl cellulose; polycycloolefin derivative; polyesters such as polyethylene-telephthalate and polyethylenenaphthalate; polyolefins such as polypropylene and polyethylene; polycarbonates; polyvinyl alcohols; polyvinyl chlorides; polyvinylidene chlorides; polyamides; polyimides; polyimide-amides; polystyrenes; polyacrylates; polymethyl methacrylates; polyether sulfones; polyarylates; and inorganic-organic composite materials such as glass fiber-epoxy resin and glass fiber-acrylic resin.

Note that transparent electrodes (ITO film, not illustrated) are provided on surfaces (hereinafter, referred to as inner surfaces) of the front substrate 1a and the back substrate 1b, which inner surfaces face each other. Pixels (pixel: a minimum unit of image display) are formed in regions partitioned by the respective transparent electrodes.

Depending on a method for driving the liquid crystal display element 10, it is possible to provide, in the inner surfaces of the pair of substrates 1, members such as electrically conductive wiring, switching elements, and insulating films. Note that the present embodiment is not limited to a specific method for driving the liquid crystal display element 10. For example, it is feasible to employ a passive matrix method or an active matrix method. Also note that, as appropriate, it is possible to further provide, on an interface between the respective inner surfaces and the liquid crystal layer 3 in the pair of substrates 1, alignment films each of which has been subjected to an alignment treatment.

The liquid crystal layer 3 is provided in the cell gap between the pair of substrates 1, and is sealed with the sealant 2 so that nothing will intrude into the gap. Note that a well known liquid crystal layer can be employed as the liquid crystal layer 3. As such, the present embodiment is not limited to any particular one.

The sealant 2 combines the pair of substrates 1 together, and seals the liquid crystal layer 3 between the pair of substrates 1. One example of the sealing material for the sealant 2 is, but is not particularly limited to, a hardening resin composition produced by adding a polymerization initiator to photo curing, thermal curing, or photothermal curing resin of an epoxy or acrylic type. In order to adjust moisture permeability, elastic modulus, and viscosity etc. of the sealant material, a type of filler made of an inorganic material or an organic material can be added to the resin composition. Examples of the form of such a filler include spherical, fibrous, amorphous, or the like. Additionally, in order to properly control the length of the cell gap, it is possible to blend, with the resin composition, gap sustainers having spherical or fibrous forms having monodispersely diameters or lengths respectively.

The plurality of spacer members 4 are provided between the pair of substrates 1 so as to sustain the cell gap between the pair of substrates 1. Each spacer member 4 is made of an elastic material. The form of each spacer member 4 is not particularly limited, and can be, with resin etc. as a material, columnar or spherical, for example.

The liquid crystal display element 10 in accordance with the present embodiment is designed such that (i) the thickness of the liquid crystal layer 3 is set to fall in a range of 93% to 98% of the heights of the spacer members 4 under no pressure applied to the spacer members 4 and (ii) adjacent spacer members 4 are separated from one another by less than 400 μm.

Note that, in the present specification, the “heights of the spacer members under no pressure” means the heights of the spacer members under no pressure created by combining the pair of substrates 1 together. Note also that the “heights of the spacer members” means heights in a direction substantially perpendicular to a surface of that one of the pair of substrates 1, on which the spacer members 4 are provided.

In the liquid crystal display element 10, the heights of the spacer members 4 are lowered as a result of a pressure created by combining the pair of substrates 1. Accordingly, the shape of the cell gap is changed. Nevertheless, since the liquid crystal layer 3 is designed to have a thickness falling in such a range as one mentioned above, the thickness of the liquid crystal layer 3 fits the length of the cell gap between the pair of substrates 1. This allows (i) an excess portion of the liquid crystal to be non-existent and (ii) the pair of substrates 1, at least one of which is flexible, to be stabilized in a state of being inwardly flexed so as to be in contact with the liquid crystal layer 3.

Also, since the spacer members are provided at intervals of less than 400 μm, the pair of substrates 1 are prevented from being excessively flexed. This allows the spacer members 4 to properly maintain the gap between the pair of substrates 1.

Therefore, it is possible to maintain a good in-plane distribution of the cell gap of the liquid crystal display element 10 in accordance with the present embodiment.

Note that the minimum value of an interval between the spacer members is not particularly limited, provided that the liquid crystal display element 10 can fulfill its function.

When manufacturing of the liquid crystal display element 10 is completed, it is possible to assess whether the thickness of the liquid crystal layer 3 falls in the range of 93% to 98% of the heights of the spacer members 4. Such assessment can be conducted by, for example, comparing (a) the length of the cell gap of the liquid crystal display element 10 and (b) the size of the spacer members 4 after the liquid crystal display element 10 is disassembled. This is because the heights of the spacer members 4 after disassembling of the liquid crystal display element 10 are equal to those of the spacer members 4 under no pressure. This phenomenon can be explained by the facts that (i) the spacer members 4 are elastic to be changeable in their forms, depending on whether or not a pressure is applied to the spacer members 4 and (ii) a change in the forms of the spacer members 4 is less than that of the cell gap since the front substrate 1a and/or the back substrate 1b, which are/is flexible, are/is slightly bent inwardly so as to be in contact with the liquid crystal layer 3.

Furthermore, by using the liquid crystal display element 10 in accordance with the present embodiment, it is possible to provide a liquid crystal display device which excels in display quality. In a case where the liquid crystal display element 10 is for use in a liquid crystal display device, the following configuration is further provided to the liquid crystal display element 10: (i) a color filter is provided on the inner surface of the front substrate 1a, (ii) an optical member such as a polarizing filter is attached to at least one of outer surfaces (surfaces opposite the inner surfaces) of the front substrate 1a and the back substrate 1b, and (iii) members are provided such as a light reflector and an illumination device for illuminating the liquid crystal display element 10. Such a configuration is similar to a configuration of a conventional liquid crystal display device, and is therefore not illustrated.

(Method for Manufacturing Liquid Crystal Display Element 10)

A method for manufacturing the liquid crystal display element 10 in accordance with the present embodiment will be described next.

The method for manufacturing the liquid crystal display element 10 in accordance with the present embodiment need only include the steps of (i) forming, on one of the pair of substrates 1, the plurality of spacer members 4 at intervals of less than 400 μm and (ii) after step (i), filling the gap between the pair of substrates 1 with such an amount of liquid crystals that the thickness of the liquid crystal layer 3 falls in the range of 93% to 98% of the heights of the spacer members 4 while no pressure is applied to the spacer members 4.

Examples of a method for filling the gap with a liquid crystal include the ODF method and the vacuum injection method. Having said that, the vacuum injection method is not suitable for handling of a flexible substrate having a low self-standing quality whereas the ODF method makes it easy to control the amount of a liquid crystal to be supplied. Therefore, the following description will discuss a case where the ODF method is employed to carry out the step (ii) (refer to [0043] in the PCT International Publication). Note, however, that the present invention is not limited to such.

In the case where the ODF method is employed to carry out the step (ii) (refer to [0043] in the PCT International Publication), the step (ii) (refer to [0043] in the PCT International Publication) includes the steps of (a) forming the sealant 2 on one of the pair of substrates 1, (b) supplying, on the substrate on which the sealant 2 is formed, such an amount of a liquid crystal that the thickness of the liquid crystal layer 3 falls in the range of 93% to 98% of the heights of the spacer members 4 while no pressure is applied to the spacer members 4, and (c) combining the pair of substrates 1 together so as to seal the liquid crystal, which was supplied in the step (ii), in the gap between the pair of substrates 1.

Each of the steps will be described below.

First, in the step (i) (refer to [0043] in the PCT International Publication), the plurality of spacer members 4 are formed on at least one (the back substrate 1b in the present case) of the pair of substrates 1 at spacer pitches of less than 400 μm. The spacer members 4 are (I) preferably formed with the use of methods in which location and density of the spacer members 4 can be controlled and (II) generally formed with the use of a dispersing means. For example, it is possible to form the spacer members 4 in columnar forms by photolithography, or to form the spacer members 4 in spherical forms by ink jet. Note here that the spacer members 4 are separated from one another by less than 400 μm.

In the step (a) (refer to [0045] in the PCT International Publication), the sealant 2 is formed (i) on one substrate (the front substrate 1a in the present case) and (ii) on the circumference of a region to be a liquid crystal sealing region. The liquid crystal sealing region is defined by forming the sealant 2. The sealant 2 is formed by use of a method such as (I) lithography using a dispenser or (II) screen printing.

In the step (b) (refer to [0045] in the PCT International Publication), a liquid crystal is supplied to the liquid crystal sealing region on the front substrate 1a on which the sealant 2 is formed. In so doing, formed is such an amount of the liquid crystal that the thickness of the liquid crystal layer 3 falls in the range of 93% to 98% of the heights of the spacer members 4 while no pressure is applied to the spacer members 4. As a method for supplying the liquid crystal, the ODF method, which makes it easy to control the amount of a liquid crystal to be supplied, is employed.

Note here that the “heights of the spacer members 4 under no pressure” means heights of the spacer members 4 having been formed as a result of carrying out the step (i) (refer to [0043] in the PCT International Publication) (a step prior to the step (c) (refer to [0045] in the PCT International Publication), which will be described later).

The amount of a liquid crystal to be supplied can be determined as follows. First, a cell capacity is derived from the product of (i) the area of the liquid crystal sealing region of the front substrate 1a and (ii) the heights of the spacer members 4 formed on the back substrate 1b. An amount falling in the range of 93% to 98% of the cell capacity thus derived is the amount of a liquid crystal to be supplied. By supplying such an amount of a liquid crystal, it is made possible to set the thickness of the liquid crystal layer 3 to fall in the range of 93% to 98% of the heights of the spacer members 4 under no pressure.

It is preferable that the cell capacity is exactly derived by carrying out the steps of (i) measuring the capacities of the spacer members 4 by use of in-line measurement and then (ii) subtracting, from the product described above, the value derived in the step (i).

In the step (c) (refer to [0045] in the PCT International Publication), the liquid crystal 3 is sealed by combining the front substrate 1a and the back substrate 1b.

Specifically, a platform having a mechanism, such as an electrostatic chuck, for causing the platform to attract a substrate is prepared. The platform is caused to attract and hold the front substrate 1a and the back substrate 1b, so as to position the pair of substrates 1 at such positions (with such distance) that (i) an alignment film of the front substrate 1a and an alignment film of the back substrate 1b face each other but (ii) the sealant 2 and the back substrate 1b are not in contact with each other. The space between the substrate 1a and the substrate 1b are depressurized while the pair of substrates 1 is in such a state. After completion of depressurization, the substrate 1a and the substrate 1b are positionally adjusted (aligned) so as to put the substrate 1a and the substrate 1b in proper positions for assembling. After completion of the alignment adjustment, the pair of substrates 1 is drawn closer to each other to such an extent that the front substrate 1a and the back substrate 1b are in contact with each other. While the pair of substrates 1 is in such a state, the space between the substrate 1a and the substrate 1b is filled with inert gas so that normal air pressure is gradually recovered. As a result, (a) the front substrate 1a and the back substrate 1b are combined together by the effect of the atmospheric pressure and (b) the cell gap is formed between the front substrate 1a and the back substrate 1b.

Specifically, when the front substrate 1a and the back substrate 1b are combined together by the effect of the atmospheric pressure, the spacer members 4 are deformed by the pressure created by the pair of substrates 1 so that the length of the cell gap between the pair of substrates 1 becomes slightly reduced. In so doing, the thickness of the liquid crystal layer 3 fits the length of the cell gap between the pair of substrates 1. This allows (i) an excess portion of the liquid crystal to be non-existent and (ii) the front substrate 1a and/or the back substrate 1b are/is to be stabilized in a state of being, to an extremely little extent, inwardly flexed so as to be in contact with the liquid crystal layer 3.

While the front substrate 1a and the back substrate 1b are in such a state, the sealant 2 is irradiated with ultraviolet rays so that the sealant 2 is cured. This is how the liquid crystal display element 10 is manufactured.

By carrying out the steps above, it is possible to manufacture a liquid crystal display element 10 in which the in-plane distribution of the liquid crystal in the cell gap has a small standard deviation so as to bring about high display quality.

Note that, although members such as active-matrix element arrays, color filters, transparent electrodes, and alignment films are formed on the front substrate 1a and on the back substrate 1b, a method for forming such is similar to a method employed in a process of manufacturing a conventional liquid crystal element, and is therefore not illustrated.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

[Example of Implementation ]

The effects of the present invention will be described next through illustrating an example of implementation. However, the present invention is not limited to the example.

With the use of the foregoing method, three types of liquid crystal display elements were built, which were provided with spacer members at intervals of 100 μm, 200 μm, and 400 μm, respectively. The amount of liquid crystal provided in the step (b) (refer to [0045] in the PCT International Publication) for supplying liquid crystal for the three types of liquid crystal display elements was varied stepwise. The in-plane distribution of a cell gap of each liquid crystal display element was measured.

The sizes of a cell and the spacer members of each liquid crystal display element were set to 3.5 inches and 15□, respectively. Also, in the step (i) (refer to [0043] in the PCT International Publication), columnar spacer members were provided with the use of the photolithography method.

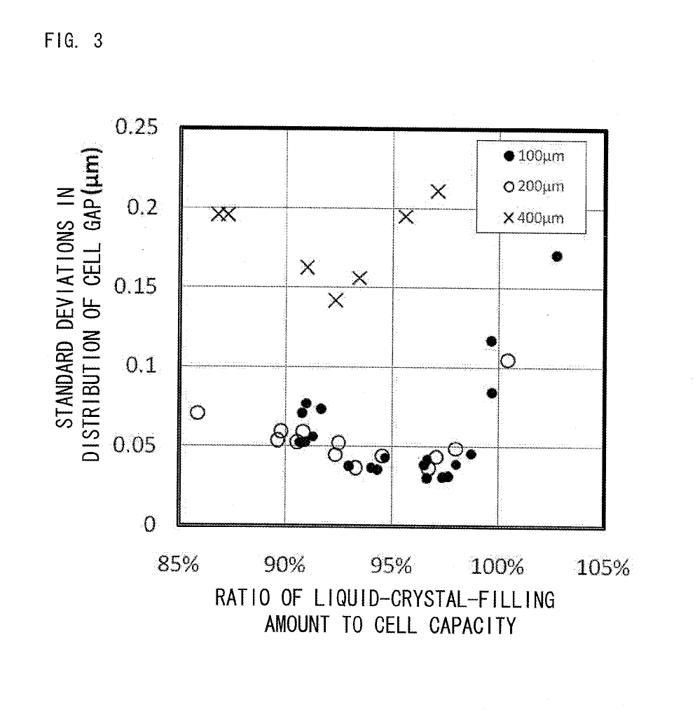

FIG. 3 shows the result of the implementation. FIG. 3 is a graph illustrating a correlation between (i) the ratio of a liquid-crystal-filling amount (the amount of the liquid crystal supplied) to the cell capacity and (ii) the standard deviation, which is to serve as the in-plane distribution of the cell gap.

Note that, in the present example, the spacer members are provided at regular intervals, and that the heights of the spacer members and the sealants are substantially equal. Therefore, the ratio of the liquid-crystal-filling amount to the cell capacity corresponds to the ratio of the thickness of a liquid crystal layer of the liquid crystal display element to the heights of the spacer members while no pressure is applied to the space members.

In the liquid crystal display elements with the spacer members provided at intervals of 100 μm and 200 μm, the standard deviations in the in-plane distributions of the cell gaps became minimal in the region where the ratio of the liquid-crystal-filling amount to the cell capacity fell within the range of 93% to 98% (see FIG. 3).

Furthermore, in the liquid crystal display elements with the spacer members provided at intervals of 100 μm and 200 μm, it was observed that bubbles appeared in the liquid crystal layer in the range where the ratio of the liquid-crystal-filling amount to the cell capacity was no greater than 92%.

In the liquid crystal display element with the spacer members provided at intervals of 400 μm, on the other hand, the standard deviation in the in-plane distribution of the cell gap in the range where the ratio of the liquid-crystal-filling-amount to the cell capacity was no greater than 98% was less than that in the range where the ratio of the liquid-crystal-filling-amount to the cell capacity was greater than 98%. However, the minimum value of the standard deviation in the in-plane distribution of the cell gap in the 400-μm liquid crystal display element was, as compared to that in the 100-μm and 200-μm liquid crystal display elements, shifted toward the left side (the side where the ratio of the liquid-crystal-filling amount to the cell capacity is less) of the horizontal axis in FIG. 3. Additionally, in the liquid crystal display element with the spacer members provided at intervals of 400 μm, bubbles did not appear in the range where the ratio of the liquid-crystal-filling amount to the cell capacity was no greater than 92%. This is presumably because widening the intervals between the spacer members caused the flexible substrate to be flexed to a greater extent accordingly. It is expected that such phenomena would be even more noticeable in a liquid crystal display element with spacer members provided at greater intervals.

Furthermore, the standard deviation in the in-plane distribution of the cell gap in the liquid crystal display element with the spacer members provided at intervals of 400 μm shows inferior results than those in the cases of the liquid crystal display elements with the spacer members provided at intervals of 100 μm and 200 μm: the standard deviations marked beyond 0.1 μm in all the measurements in which the ratios of the liquid-crystal-filling amounts to the cell capacities were altered from one another (see FIG. 3).

It is difficult to establish quantitative correlations between (i) a standard deviation in an in-plane distribution of a cell gap and (ii) display quality. Nevertheless, the following result was obtained from a visual observation with eyes: mottle clearly appeared on displays of the liquid crystal display elements built for the present example when the liquid crystal display elements had the standard deviations of greater than 0.1 μm in the in-plane distributions of the cell gaps.

Hence, it has been confirmed that it is possible to maintain a well-balanced in-plane distribution of a cell gap in a case where (i) spacer members provided in a liquid crystal display element are provided at intervals of less than 400 μm and (ii) the ratio, of the thickness of a liquid crystal layer in a liquid crystal display element to the heights of spacer members while no pressure is applied to the spacer members, falls in a range of 93% to 98%.

### INDUSTRIAL APPLICABILITY

The present invention is widely applicable to liquid crystal display elements using a flexible substrate.

### REFERENCE SIGNS LIST

1 Pair of substrate

1a Front substrate

1b Back substrate

2 Sealant

3 Liquid crystal layer

4 Spacer member

10 Liquid crystal display element

1. A liquid crystal display element comprising:
a pair of substrates, at least one of which is a flexible substrate;
a liquid crystal layer sealed in between the pair of substrates;
a plurality of spacer members, provided between the pair of substrates, which sustain a gap between the pair of substrates; and
a sealant for sealing the liquid crystal layer and for solely playing a role of combining the pair of substrates together,
the liquid crystal layer having a thickness falling in a range of 93% to 98% of heights of the spacer members in a thickness direction of the liquid crystal layer, which heights the spacer members have under no pressure applied to the spacer members, and
the spacer members being provided at intervals of less than 400 μm therebetween.

2. A liquid crystal display device comprising a liquid crystal display element as set forth in claim 1.

3. A method for manufacturing a liquid crystal display element,
said liquid crystal display element, comprising:
a pair of substrates, at least one of which is a flexible substrate;
a liquid crystal layer sealed in between the pair of substrates;
a plurality of spacer members, provided between the pair of substrates, which sustain a gap between the pair of substrates; and a sealant for sealing the liquid crystal layer and for solely playing a role of combining the pair of substrates together,
said method, comprising the steps of:
(i) providing, on one of the pair of substrates, the plurality of spacer members at pitches of less than 400 μm; and
(ii), after the step (i), sealing a liquid crystal in between the pair of substrates, the liquid crystal being sealed in such an amount that the liquid crystal layer will have a thickness falling in a range of 93% to 98% of heights of the spacer members in a thickness direction of the liquid crystal layer, which heights the spacer members have under no pressure applied to the spacer members; and
(iii), after the step (ii), sealing the liquid crystal layer by use of the sealant as well as combining the pair of substrates together by use of the sealant alone.
